(19) United States
(12) Patent Application Publication
(10) Pub. No.: US 2005/0190788 A1
(43) Pub. Date: Sep. 1, 2005

(54) System and method for VLAN multiplexing

(76) Inventors: Yu-Man Matthew Wong, San Diego, CA (US); Jim Sung, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/067,868

(22) Filed: Feb. 28, 2005

Related U.S. Application Data
(60) Provisional application No. 60/548,616, filed on Feb. 27, 2004.

(51) Int. Cl. H04J 3/22; H04J 3/16; H04L 12/56; H04L 12/28

(52) U.S. Cl. 370/466

(57) ABSTRACT

Systems and methods to implement a shared access gateway are provided that facilitate the multiplexing of multiple enterprise VLAN segments through a single device that translates the VLAN communications from the multiple enterprise segments on the customer side into VLAN communications for delivery over a network service provider network. A single shared access gateway is deployed that is connected to multiple enterprise side network segments. SVLAN controller modules monitor the enterprise side ports of the shared access gateway and processes communications received from those ports. Each SVLAN controller module uses IVL and SVL to maintain its separate forwarding database as packets ingress from the customer side and get processed by the SVLAN controller module. A plurality of translation functions are employed for proper encapsulation of VLAN traffic for transmission over a particular service provider network.

### RELATED APPLICATION

01 μl The present application claims priority to U.S. provisional patent application Ser. No. 60/548,616 filed on Feb. 27, 2004 which is incorporated herein by reference in its entirety.

### BACKGROUND

1. Field of the Invention

The present invention generally relates to VLAN network administration and more particularly relates to VLAN switching and service provider side LAN-MAN translation.

2. Related Art

Conventional virtual local area networks (“VLANs”) were first developed as a technology to divide local area networks (“LANs”) into logical segments for performance and privacy reasons. The IEEE 802.1Q and 802.1p standards provide the specification for conventional VLAN behavior. More recently, wide are network (“WAN”) and metropolitan area network (“MAN”) service providers have extended the VLAN technology as a means to provide transparent LAN services (“TLS”) between remote sites among enterprises.

Conventional VLANs under the IEEE standards are somewhat limited in their application because the context of a VLAN segment is local (i.e., enterprise-specific) and the maximum number of VLANs in any local context is restricted to 4,094. In order to circumvent these limitations, network service providers must employ a device that translates the enterprise-side VLAN identifier into a service provider side VLAN identifier when providing TLS services to an enterprise that uses one or more VLANs. Such a device is typically referred to as customer premise equipment (“CPE”) and uses translation techniques such as VLAN-in-VLAN encapsulation (also referred to herein as “Q-in-Q encapsulation” or “VLAN stacking”).

Although a CPE translation device allows a network service provider to carry traffic for an enterprise, the service provider must deploy a separate CPE translation device for each enterprise due to the potential overlapping of the limited 4,094 VLAN ID address space at separate enterprises. Additionally, the service provide must also ensure that the VLAN IDs traveling over its network remain unique. Accordingly, to support a VLAN-based transparent LAN service over a WAN or MAN, a network service provider requires each enterprise to have its own VLAN switch which is capable of providing the LAN-MAN VLAN ID translation to maintain traffic transparency. Furthermore, the enterprise must also have a separate device to handle enterprise side VLAN switching. Therefore, what is needed is a system and method that overcomes these significant problems found in the conventional systems.

### SUMMARY

Accordingly, systems and methods are provided that facilitate the multiplexing of multiple enterprise VLAN segments through a single device that translates the VLAN IDs from the multiple enterprise segments on the customer side into unique VLAN IDs for the network service provider. A single shared access gateway is deployed that is connected to multiple enterprise side (also referred to herein as “customer side”) network segments. These connections are each monitored by a super VLAN (“SVLAN”) controller module that maintains a separate forwarding database to track MAC addresses of network devices and their corresponding communication ports. Each SVLAN controller module uses shared VLAN learning (“SVL”) to maintain its forwarding database (also referred to herein as a “MAC address table”) as packets ingress from the customer side and are processed by the SVLAN controller module. Additionally, the system of multiple SVLAN controllers uses independent VLAN learning (“IVL”) in combination with the SVL to provide VLAN multiplexing.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a network diagram illustrating an example wide area network topology according to an embodiment of the present invention;

FIG. 2 is a block diagram illustrating an example shared access gateway according to an embodiment of the present invention;

FIG. 3 is a block diagram illustrating an example forwarding database according to an embodiment of the present invention;

FIG. 4 is a block diagram illustrating an example shared access gateway with SVLAN controller and translator modules according to an embodiment of the present invention;

FIG. 5 is a flow diagram illustrating an example method for shared access gateway processing of communication frames according to an embodiment of the present invention; and

FIG. 6 is a block diagram illustrating an exemplary computer system as may be used in connection with various embodiments described herein.

### DETAILED DESCRIPTION

Certain embodiments disclosed herein provide for systems and methods for implementing a shared access gateway that allows dynamic multiplexing of multiple customer side VLANs across one or more service provider networks to implement transparent LAN services over a WAN. For example, one method as disclosed herein allows for a shared access gateway to employ a plurality of super VLAN (“SVLAN”) controllers that each monitors a specific group or enterprise/customer. Incoming traffic on a user port is processed by the SVLAN controller that is monitoring that port and communication frames are switched over to the appropriate port for delivery to the destination address. The delivery port may be a user port (where customer side network devices are located) or a trunk port (for delivery over the network service provider network).

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

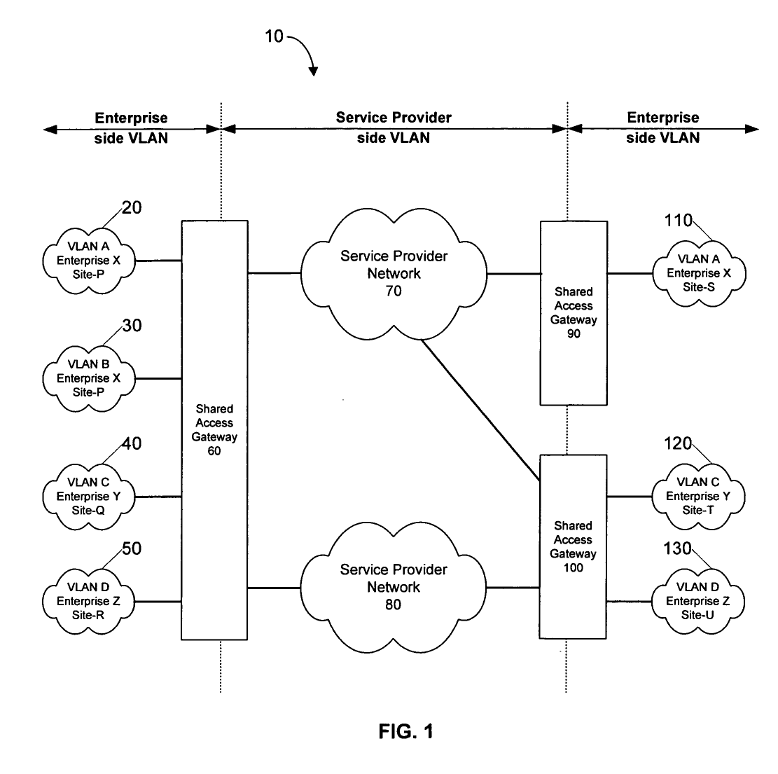

FIG. 1 is a network diagram illustrating an example wide area network topology according to an embodiment of the present invention. In the illustrated embodiment, the system 10 comprises a plurality of enterprise side network segments 20, 30, 40, and 50. Each network segment is communicatively coupled with shared access gateway (“SAG”) 60 on the enterprise side. The SAG 60 is also communicatively coupled with service provider networks 70 and 80. In alternative embodiments, SAG 60 may be communicatively coupled with more or fewer enterprise side network segments and more or fewer service provider side service provider networks. Additionally in the illustrated embodiment, the service provider networks 70 and 80 communicatively couple SAGs 90 and 100 and their corresponding enterprise side network segments 110, 120, and 130.

The SAG 60 can be employed as a shared access device in environment such as a multi-tenant or multi-dwelling complex. The SAG 60 may also be employed as an edge device in a service provider network such as networks 70 or 80. The external interfaces in the SAG 60 can be based on any wired or wireless technology which supports Ethernet MAC frame transport (e.g., xDSL, optical, 802.11a/b/g, etc). Advantageously, the SAG 60 is content neutral and therefore inherently supports the delivery of multi-services, such as voice, data, video and any combination of these and alternative types of content. Additionally, the SAG 60 inherently supports QoS via mechanisms such as those based on the IEEE 802.1p or 802.1Q standards or IP-based TOS/DiffServ.

In the illustrated embodiment, network segments 20, 30, 40, and 50 can be any of a variety of customer side networks. In one embodiment, network segment 20 is a network owned by enterprise X and located at site P. The network segment 20 is configured to be part of VLAN A. Additionally, network segment 30 is also network owned by enterprise X and located at site P. The network segment 30 is configured to be part of VLAN B. In alternative embodiments, a single network segment may comprise multiple networks with multiple network devices connected to each of the multiple networks. To simplify the description, however, the primary embodiment described herein will refer to a network segment as a single network with one or more network devices attached thereto.

Similarly, in alternative embodiments, a single network segment may be configured with devices that individually belong to different VLANs. Accordingly, a single network segment may carry traffic for more than one VLAN. To simplify the description, however, the primary embodiment described herein will describe a network segment as having one or more network devices that all belong to a single VLAN.

Furthermore, although network segments 20, 30, 40, and 50 are shown to be VLAN network segments, the present invention is not limited to VLAN network segments on the enterprise side. Other types of network segments such as a LAN using transparent LAN services (“TLS”), frame relay, or the like over a service provider network may also be employed. In an embodiment where a network segment implements TLS services, the network segment can be assigned a reserved identifier to implement the VLAN translation services provided by a shared access gateway. For example, a VLAN ID (“VID”) that is not within the allowable VID address space can be used for this purpose.

In alternative embodiments, other types of network services for different network segments can also be handled in this fashion. For example, the shared access gateway module 60 can support legacy non-VLAN based enterprise networks by converting non-VLAN traffic into VLAN-based traffic using service provider assigned VLAN ID techniques such as port-based VID (“PVID”) assignment.

In the illustrated embodiment, network segment 40 is a network owned by enterprise Y, is located at site Q, and is configured to be part of VLAN C. Also in the illustrated embodiment, network segment 50 is a network owned by enterprise Z, located at site R, and configured to be part of VLAN D.

Network segment 20 is communicatively coupled with network segment 110 via the infrastructure of shared access gateways 60 and 90 and service provider network 70. As shown in the illustrated embodiment, both network segments 20 and 110 are configured to be part of VLAN A, although they are located at different physical locations (site P and site S, respectively) that are owned by enterprise X. Thus, the VLAN A extends across a wide area network including network segments 20 and 110, shared access gateways 60 and 90 and service provider network 70.

Similarly, VLAN C owned by enterprise Y and VLAN D owned by enterprise Z also extend across a wide area network. The VLAN C may extend across service provider network 70 or service provider network 80, or both and also includes shared access gateways 60 and 100 and network segments 40 and 120. VLAN D extends across service provider network 80 and also includes shared access gateways 60 and 100 and network segments 50 and 130.

Advantageously, in one embodiment VLANs B & C can both use the same VLAN ID. For example, VLAN B for enterprise X may be assigned VLAN ID 1000. Additionally, VLAN C for enterprise & can also be assigned VLAN ID 1000. This re-use of VLAN IDs across enterprises allows a single shared access gateway module or device to service multiple enterprises, regardless off a particular enterprises use of the VLAN address space for its internal VLANs.

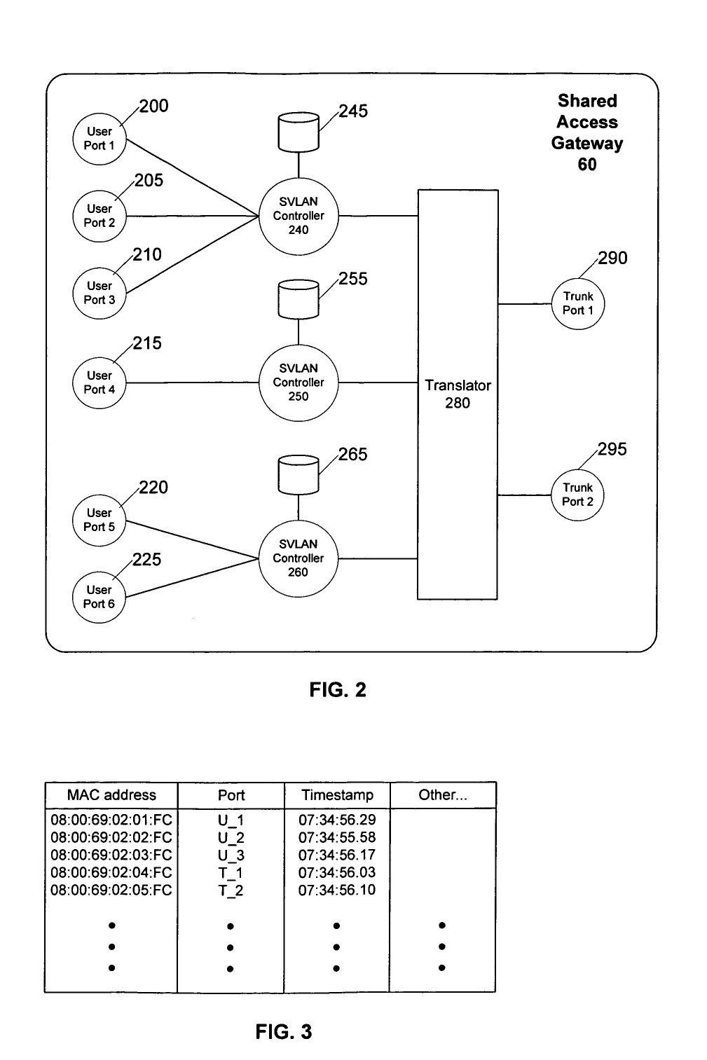

FIG. 2 is a block diagram illustrating an example shared access gateway module 60 according to an embodiment of the present invention. In the illustrated embodiment, the shared access gateway module 60 comprises a plurality of SVLAN controller modules that each monitor one or more communication ports. A communication port can be a source port or a destination port and may also be referred to herein as a user port (enterprise side) or a trunk port (network service provider side). For example, SVLAN controller module 240 is configured to monitor ports 200, 205, and 210. Also, SVLAN controller module 250 is configured to monitor port 215 and SVLAN controller module 260 is configured to monitor ports 220 and 225.

In the illustrated embodiment, each SVLAN controller modules 240, 250, and 260 each maintain a separate forwarding database 245, 255, and 265, respectively. The forwarding database is described in further detail with respect to FIG. 3. Additionally, each SVLAN controller module is communicatively coupled with the translator module 280.

The translator module 280 performs translation of network communications (also referred to herein as frames or packets) so that communications from an originating network device in a particular VLAN (with its respective VLAN ID) are compatible with the service provider network that may assign VLAN IDs in a different fashion. Advantageously, the translator module 280 may perform a plurality of different types of translation as needed by the various service providers that are connected to the shared access gateway module 60 through the plurality of communication ports such as ports 290 and 295. It should be noted that the number of user ports and trunk ports may vary across different implementations of the shared access gateway module 60. Furthermore, it should be understood that the shared access gateway module 60 may be implemented in hardware, software, or some combination of the two such as a system on chip (“SOC”) or ASIC.

FIG. 3 is a block diagram illustrating an example forwarding database according to an embodiment of the present invention. In the illustrated embodiment, the forwarding database (also referred to herein as a “MAC address table”) comprises a plurality of entries that can be uniquely indexed by the MAC address field or a combination of MAC address and other fields. As the SVLAN controller module processes frames, it updates the forwarding database with the MAC address of the source network device and the port on which the frame was received. The frame may be received from a user port or a trunk port. Additionally, the forwarding database may include a time indicator that allows an entry to expire. For example, a time indicator may be a timestamp associated with the most recently received frame. Other information helpful to the management of VLAN communications may also be included in the forwarding database.

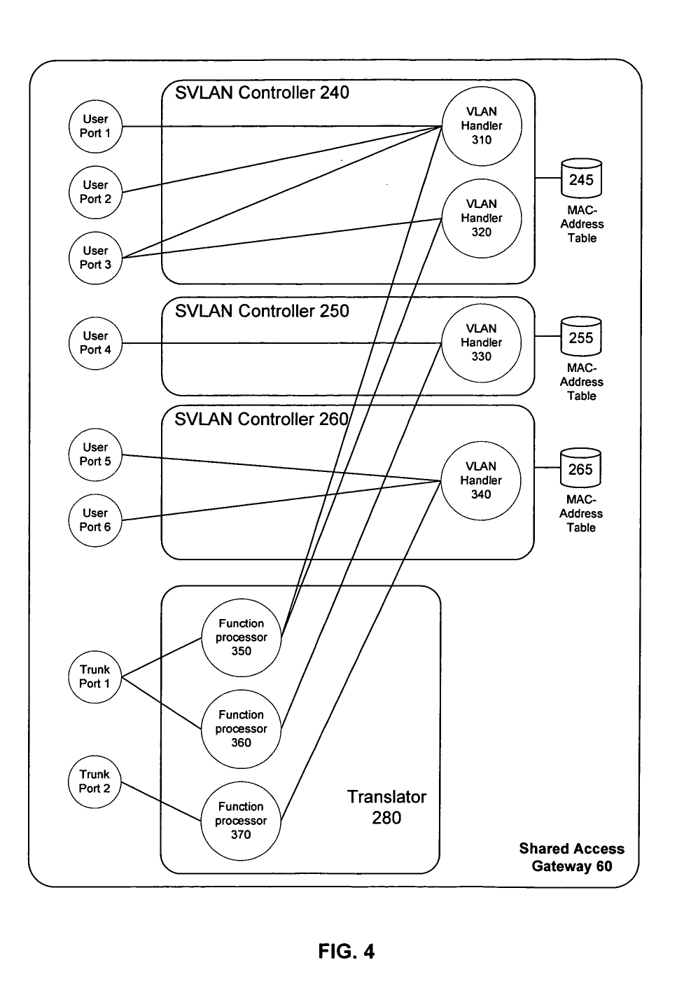

FIG. 4 is a block diagram illustrating an example shared access gateway module 60 with SVLAN controller modules 240, 250, and 260 and translator module 280 according to an embodiment of the present invention. In the illustrated embodiment, SVLAN controller module 240 is configured to monitor communication ports including user ports 1, 2, and 3 and comprises VLAN handler modules 310 and 320 that show the function of individual VLAN processing by the SVLAN controller module 240.

For example, VLAN handler module 310 processes network communications for a particular VLAN ID. According to one embodiment, VLAN handler module 310 may be configured to process all network communications for VLAN 310. Similarly, VLAN handler module 320 may be configured to process all network communications for VLAN 320. Additionally, network devices belonging to VLAN 310 are located on network segments that are connected to user ports 1, 2, and 3. Thus, VLAN handler module 310 may receive frames from any of these user ports. However, in the illustrated embodiment, network devices belonging to VLAN 320 are located only on the network segment that is connected to user port 3. Thus, VLAN handler module 320 receives frames only from user port 3. Note that SVLAN controller module 240 maintains the MAC address table 245 for all network communications received on all of the user ports (and accordingly all of the VLAN IDs) it monitors. The use of a single MAC address table 245 by the SVLAN controller module 240 that monitors more than one VLAN is an implementation of shared VLAN learning and allows the SVLAN controller 240 to perform the enterprise VLAN switching function while at the same time the shared access gateway module 60 performs the LAN-MAN VLAN translation function. Additionally, the same VLAN ID can be used across SVLAN controller modules. For example, VLAN ID 1000 could be used for a VLAN being monitored by SVLAN controller module 240 and also used for a VLAN being monitored by SVLAN controller module 250.

Similar configurations are also shown for SVLAN controller module 250 that is monitoring user port 4 and SVLAN controller module 260 that is monitoring user ports 5 and 6. In the illustrated embodiment, SVLAN controller module 250 is shown with VLAN handler 330 for processing packets for the VLAN with ID 330 that is located on the network segment connected to user port 4. SVLAN controller module 250 maintains the MAC address table 255. Also, SVLAN controller module 260 is shown with VLAN handler 340 for processing packets for the VLAN with ID 340 that is located on the network segments connected to user ports 5 and 6. SVLAN controller module 260 maintains the MAC address table 265.

The frames that are processed by the VLAN handler modules are forwarded to the translator module 280 for translation prior to transmission over the service provider network (not shown) via a communication port such as trunk ports 1 and 2. The translator module 280 is shown having a plurality of function processor modules 350, 360, and 370 to illustrate the function of translating frames according to various translation schemes such as VLAN-in-VLAN encapsulation (also referred to as Q-in-Q encapsulation).

Advantageously, frames sent to a particular function processor module can be encapsulated or translated and then transmitted over the service provider network for delivery to the destination address. The reverse translation or de-encapsulation process takes place on the delivery end where the translator module 280 provides the frame to the appropriate SVLAN controller module for transmission on the appropriate communication port based on a lookup in the MAC address table for the destination MAC address.

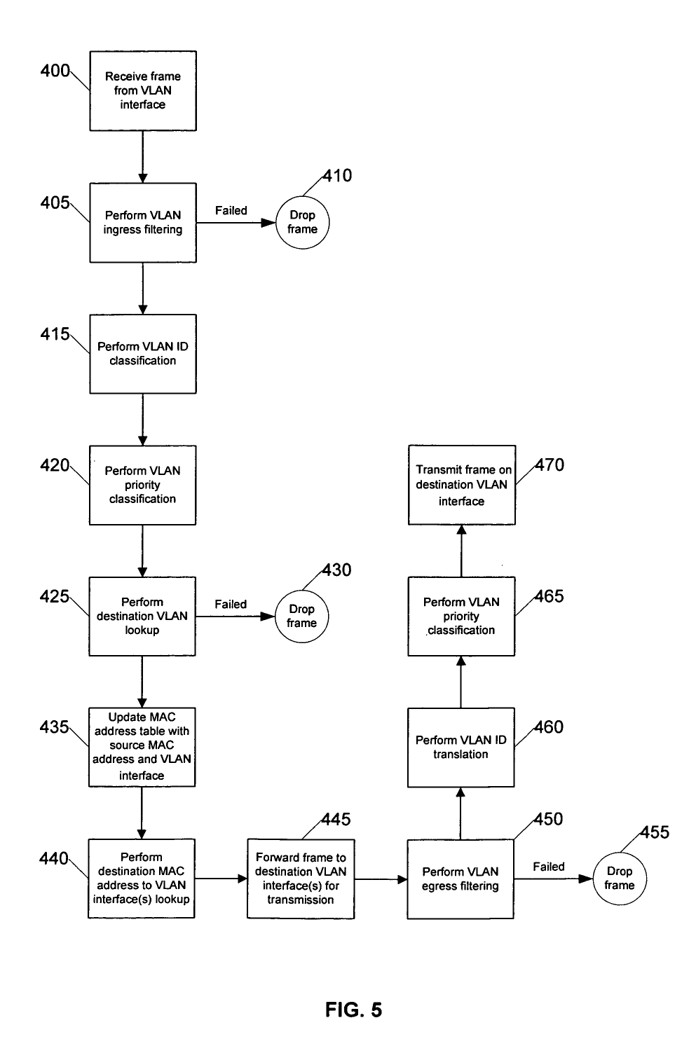

FIG. 5 is a flow diagram illustrating an example method for shared access gateway processing of communication frames according to an embodiment of the present invention. Initially, in step 400, the SVLAN controller module receives a frame from a communication port. In one embodiment, quality of service (“QoS”) and bandwidth control can be implemented when the frame is received. For example, QoS may advantageously be performed if the communication port is a wireless network connection. Next, in step 405 the frame is processed through VLAN ingress filtering. This filtering may include evaluating the VLAN tagging status of the frame. In one embodiment, frames that lack the appropriate VLAN tag are dropped, as shown in step 410. Other filtering techniques may also be employed to ensure that only valid frames are processed further and thereby optimize frame processing and throughput.

After ingress filtering, the frame is next analyzed for VID classification. In one embodiment, on the enterprise side port based VID (“PVID”) can be employed to determine the VID of the incoming frame. In some instances, the VID will be known based on the port itself, however, if multiple VLANs are assigned to a single network segment, then each frame can be filtered to determine its VID. In an embodiment where the network segment is using TLS, then all incoming frames can advantageously be assigned to the TLS VLAN that is in place for the particular port. On the service provider side a VID mapping process can be used to determine the VID assignment of the incoming frame.

Next, in step 420 VLAN priority classification takes place. This process establishes the priority of the frame, for example, based on the IEEE 802.1p standard, IP TOS/DiffServ, and the like. Once the priority of the frame has been established a destination VLAN lookup is performed, as shown in step 425. The destination VLAN lookup determines the VLAN ID to which the frame is directed. This can be determined based on the assigned VLAN tag. If the destination VLAN lookup fails, for example, when port of the incoming frame is not a member of the destination VLAN, then the frame is dropped, as illustrated in step 430. For example, in one embodiment traffic is only permitted between ports that are members of the same VLAN. In an embodiment where the network segment from which the frame originates is a TLS network segment, then the TLS traffic is directed to the TLS VLAN ID assigned to the port at which the frame was received.

If the frame passes the destination VLAN lookup, then the MAC address table is updated, as shown in step 435. The information from the incoming frame that is updated or added into the MAC address table can include the MAC address of the source network device, the communication port on which the frame was received, and a timestamp or other timing information that allows the entry in the MAC address table to expire after a certain period of time elapses that causes the entry to become stale.

Advantageously, each SVLAN controller module maintains a separate MAC address table that is shared for all of the VLAN IDs of the enterprise that the SVLAN controller module is responsible for. This shared MAC address table allows the SVLAN controller module to implement shared VLAN learning within the communications for an enterprise.

Additionally, because each SVLAN controller module maintains a separate MAC address table, the SVLAN controller module is able to implement independent VLAN learning across enterprises. This combination of shared VLAN learning within an enterprise and independent VLAN learning across enterprises is particularly advantageous for implementing the shared access gateway to multiplex communications between the VLAN network segments of multiple enterprises across multiple network service providers.

Next, in step 440 the destination MAC address to VLAN interface lookup is performed. This step identifies the egress port to which the frame should be sent for delivery over the service provider network. Alternatively, the frame may be destined for delivery via a user port such that it would not be delivered over a service provider network. In either case, once the destination VLAN interface is determined, then the frame is forwarded to that port in step 445. If the destination VLAN interface is not determined, then the frame is broadcast to all of the VLAN interfaces that are associated with the particular VLAN ID.

After forwarding the frame to the VLAN interface, VLAN egress filtering may be performed in step 450 to determine the compatibility of the frame for transmission. For example, filters such as those described in IEEE 802.1Q or other can be applied. If the frame does not pass the filtering step, it is discarded in step 455. If the frame passes the filtering step, then VLAN ID translation is performed in step 460.

In one embodiment, during VLAN ID translation the VLAN ID on the enterprise side remains intact. Alternatively, the VLAN ID on the enterprise side may also undergo a transformation to help determine the particular VLAN ID to be used when the frame is transmitted over the service provider network.

In one embodiment, on the service provider side, unique VLAN IDs are maintained across the service provider network. Accordingly a Q-in-Q encapsulation process may be performed in the VLAN translation step to assign a new VLAN ID to the frame for transmission across the service provider network. This can be referred to as LAN-MAN translation since the VLAN ID for the network segment (e.g., LAN) is translated into a VLAN ID for the service provider network (e.g., MAN).

The particular LAN-MAN translation function can be set up administratively, and may include standard transformation techniques such as VLAN-in-VLAN encapsulation, which inserts an additional 4-byte VLAN tag containing a transformed unique VLAN ID into the frame immediately after the source and destination address field. Additionally, a configurable Ether-type field may also be included in the inserted tag to improve interoperability with various MAN switches. Other VLAN ID translations can also be used. In one embodiment, additional control can be applied to manage the egress tagging behavior (e.g., tagged or untagged). For example, the translator should be configured for tagged egress operation on a trunk port where there may be an aggregation of frames from multiple SVLAN controller modules. In an alternative embodiment, VLAN IDs from the enterprise side can be remapped to a VLAN ID for the network service provider side.

After the VLAN ID translation, the VLAN priority classification for the frame is performed in step 465. A frame can be classified with a priority such as those identified in IEEE 802.1p, IP TOS/DiffServ, and others. Once the priority classification has been completed, the frame is transmitted on the port identified for the destination VLAN interface, as illustrated in step 470. Egress QoS and bandwidth control policies may also be implemented at this time to determine the compatibility of the frame for transmission.

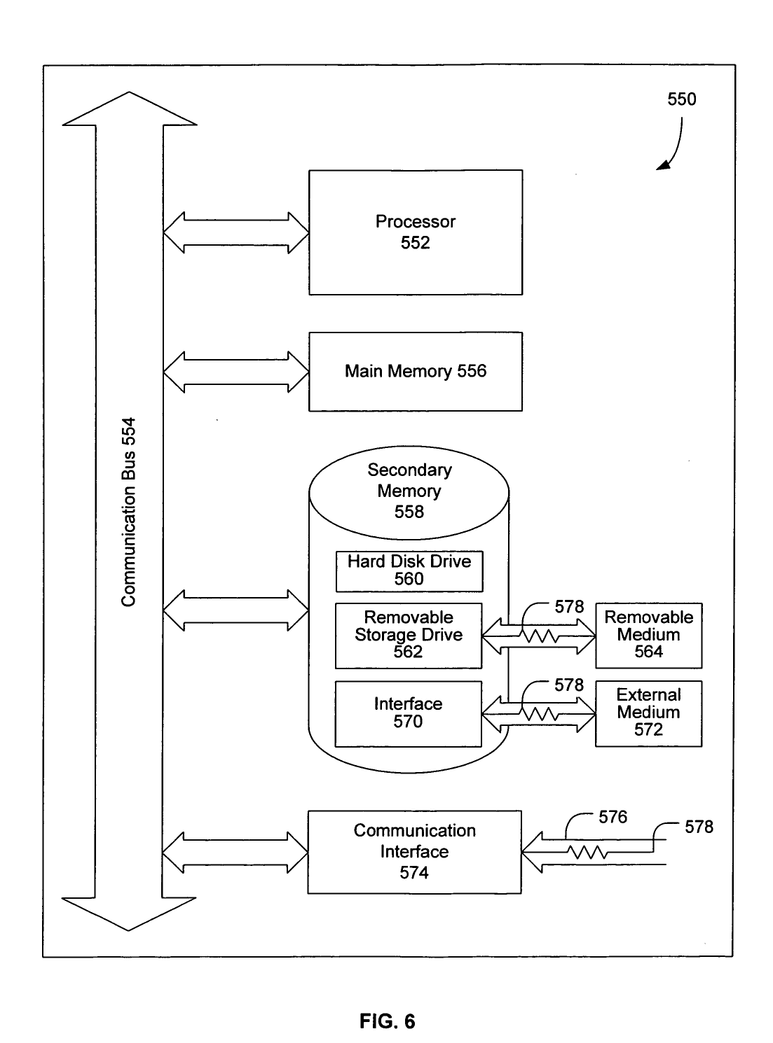

FIG. 6 is a block diagram illustrating an exemplary computer system 550 that may be used in connection with the various embodiments described herein. For example, the computer system 550 may be used in conjunction with the shared access gateway described herein. The computer system may be implemented as a stand alone device, as an integrated as part of a larger device, or implemented as a system-on-chip. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A computer implemented system for translating virtual local area network (VLAN) communications from a plurality of enterprise side network segments for transmission over a plurality of carrier networks, the system comprising:
a plurality of controller modules, each controller module configured to monitor one or more source ports for VLAN network communications from one or more network devices, wherein each network device has a unique media access control (MAC) address and a VLAN identifier;
a plurality of forwarding databases, each forwarding database comprising one or more entries having a MAC address, an associated port, and a time indicator, wherein each controller module maintains a separate forwarding database; and
a translator module having one or more translation function processors, each translation function processor assigned to a destination port for delivery of translated network communications, wherein a translation function processor receives network communications from one or more of the plurality of controller modules and translates the network communications for transmission over a destination port and delivery via a network service provider network.

2. A computer implemented method for translating virtual local area network (VLAN) communications from a plurality of enterprise side network segments for transmission over a plurality of carrier networks, the method comprising:
receiving a network communication from a source network device via a source VLAN interface;
updating a media access control (MAC) address field and a VLAN interface field for the source network device in a forwarding database comprising entries for one or more network devices communicating over the source VLAN interface;
parsing a destination MAC address from the network communication;
identifying a destination VLAN interface for the destination MAC address, wherein the destination VLAN interface is associated with a carrier network;
translating the network communication to a format compatible with the carrier network; and
transmitting the network communication over the destination VLAN interface.

3. A computer readable medium having stored thereon one or more sequences of instructions for causing one or more microprocessors to perform the steps for translating virtual local area network (VLAN) communications from a plurality of enterprise side network segments for transmission over a plurality of carrier networks, the steps comprising:
receiving a network communication from a source network device via a source VLAN interface;
updating a media access control (MAC) address field and a VLAN interface field for the source network device in a forwarding database comprising entries for one or more network devices communicating over the source VLAN interface;
parsing a destination MAC address from the network communication;
identifying a destination VLAN interface for the destination MAC address, wherein the destination VLAN interface is associated with a carrier network;
translating the network communication to a format compatible with the carrier network; and
transmitting the network communication over the destination VLAN interface.
